(19) United States
(12) Patent Application Publication
(10) Pub. No.: US 2024/0142346 A1
(43) Pub. Date: May 2, 2024

(54) OPERATING CONDITION DECISION DEVICE, OPERATION ASSISTANCE DEVICE, CONTROL DEVICE, AND OPERATING CONDITION DECISION METHOD FOR ROTATING MACHINE

(71) Applicant: MITSUBISHI HEAVY INDUSTRIES, LTD., Tokyo (JP)

(72) Inventors: Satoshi Kumagai, Tokyo (JP); Ryo Kawabata, Tokyo (JP); Shuichi Ishizawa, Tokyo (JP); Masahiko Yamashita, Yokohama-shi (JP); Yoshinori Tanaka, Yokohama-shi (JP); Shinnosuke Haga, Yokohama-shi (JP)

(73) Assignee: MITSUBISHI HEAVY INDUSTRIES, LTD., Tokyo (JP)

(21) Appl. No.: 18/278,301

(22) PCT Filed: Mar. 2, 2022
(86) PCT No.: PCT/JP2022/008736

§ 371 Date: Aug. 22, 2023

(30) Foreign Application Priority Data
Mar. 4, 2021 (JP) 2021-034623

(51) Int. Cl. G01M 99/00

(52) U.S. Cl. CPC G01M 99/005

(57) ABSTRACT

An AE signal is acquired from an AE sensor disposed on a fixed part of the rotating machine, and the presence or absence of rubbing in the rotating machine is determined, based on the AE signal. As a result, if the rubbing is determined to be present, a rubbing suppression operating condition imposed on control of the rotating machine is decided to suppress the rubbing.

### TECHNICAL FIELD

The present disclosure relates to an operating condition decision device, an operation assistance device, a control device, and an operating condition decision method for a rotating machine.

The present application claims priority based on Japanese Patent Application No. 2021-034623 filed on Mar. 4, 2021, the entire content of which is incorporated herein by reference.

### BACKGROUND ART

Conventionally, rubbing detection in a rotating machine has been performed by detecting shaft vibration of a rotational shaft. Shaft vibration of a rotational shaft can be caused by rubbing between the rotational shaft and a seal or the like due to thermal deformation of a casing, and thermal bending of the rotational shaft due to heat generated by rubbing. The occurrence of such rubbing causes shaft vibration of the rotating machine and performance reduction due to seal deterioration. Further, since shaft vibration of a rotational shaft is a phenomenon that can be detected when rubbing has progressed to the extent that thermal bending occurs in the rotor, if rubbing is detected by shaft vibration, it may require emergency stopping of the rotating machine or other actions that would have a significant impact on the operation of the rotating machine. Therefore, early detection of rubbing is desired.

In order to solve such problems, techniques have been proposed for detecting rubbing at an earlier stage than in the past by using acoustic signals. For example, Patent Document 1 discloses a device capable of diagnosing the presence or absence of rubbing in a rotating machine using acoustic signals based on sound generated by an abnormal phenomenon of a rotating body of a rotating machine in a plant.

### CITATION LIST

### Patent Literature

Patent Document 1: JP3393908B

### SUMMARY

### Problems to be Solved

The occurrence of rubbing in a rotating machine is a factor that reduces the operating range of the rotating machine, such as emergency stopping of the rotating machine, as described above. In Patent Document 1, rubbing can be detected at an earlier stage than in the past by diagnosis of rubbing based on acoustic signals, but how to control the rotating machine after detecting the rubbing to improve the operating range of the rotating machine has not been examined. In addition, rubbing in a rotating machine tends to occur when there are fluctuations in the load of the rotating machine, such as at startup, during load changes, and when shifting to low-load operation mode. Therefore, excessive margins are set for the operating conditions of the rotating machine in these cases, and the operating range of the rotating machine is restricted.

At least one embodiment of the present invention was made in view of the above circumferences, and an object thereof is to provide an operating condition decision device, an operation assistance device, a control device, and an operating condition decision method for a rotating machine whereby it is possible to extend the operating range of the rotating machine by accurately determining an operating condition to suppress rubbing when the rubbing is detected based on acoustic signals in the rotating machine.

### Solution to the Problems

To solve the above problems, an operating condition decision device for a rotating machine according to at least one embodiment of the present invention includes: an AE sensor, disposed on a fixed part of the rotating machine, for acquiring an AE signal of the rotating machine; a determination part for determining the presence or absence of rubbing in the rotating machine, based on the AE signal; and an operating condition decision part for, if the determination part determines that the rubbing is present, deciding a rubbing suppression operating condition imposed on control of the rotating machine to suppress the rubbing.

To solve the above problems, an operation assistance device for a rotating machine according to at least one embodiment of the present invention includes: the operating condition decision device for the rotating machine according to at least one embodiment of the present invention; a rubbing occurrence region identification part for identifying a rubbing occurrence region for a parameter related to the operating state of the rotating machine; and a display part for displaying the rubbing occurrence region.

To solve the above problems, a control device for a rotating machine according to at least one embodiment of the present invention includes: the operating condition decision device for the rotating machine according to at least one embodiment of the present invention; and a control part for controlling the rotating machine, based on the operating condition decided by the operating condition decision device.

To solve the above problems, an operating condition decision method for a rotating machine according to at least one embodiment of the present invention includes: a step of, disposed on a fixed part of the rotating machine, acquiring an AE signal of the rotating machine; a step of determining the presence or absence of rubbing in the rotating machine, based on the AE signal; and a step of, if the rubbing is determined to be present, deciding a rubbing suppression operating condition imposed on control of the rotating machine to suppress the rubbing.

### Advantageous Effects

At least one embodiment of the present invention provides an operating condition decision device, an operation assistance device, a control device, and an operating condition decision method for a rotating machine whereby it is possible to extend the operating range of the rotating machine by accurately determining an operating condition to suppress rubbing when the rubbing is detected based on acoustic signals in the rotating machine.

### BRIEF DESCRIPTION OF DRAWINGS

FIG. 1 is a configuration diagram of an operating condition decision device according to the present embodiment, with a rotating machine.

FIG. 2 is a graph showing the amplitude of AE signals after envelope processing for each rotation order.

FIG. 3 is a graph showing the time series distribution of rubbing detection index.

FIG. 4 is a graph showing the cumulative probability of rubbing detection index.

FIG. 5 shows examples of the rubbing suppression operating condition set for some operation modes.

FIG. 6 is a configuration diagram of an operation assistance device for a rotating machine equipped with the operating condition decision device of FIG. 1.

FIG. 7 is an example of a map created by the map creation part of FIG. 6.

FIG. 8 is another example of a map created by the map creation part of FIG. 6.

FIG. 9 is a configuration diagram of a control device for a rotating machine equipped with the operating condition decision device of FIG. 1.

### DETAILED DESCRIPTION

Embodiments of the present disclosure will be described below with reference to the accompanying drawings. It is intended, however, that unless particularly identified, dimensions, materials, shapes, relative positions, and the like of components described in the embodiments shall be interpreted as illustrative only and not intended to limit the scope of the present disclosure.

For instance, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same” “equal” and “uniform” shall not be construed as indicating only the state in which the feature is strictly equal, but also includes a state in which there is a tolerance or a difference that can still achieve the same function.

Further, for instance, an expression of a shape such as a rectangular shape or a cylindrical shape shall not be construed as only the geometrically strict shape, but also includes a shape with unevenness or chamfered corners within the range in which the same effect can be achieved.

On the other hand, an expression such as “comprise”, “include”, “have”, “contain” and “constitute” are not intended to be exclusive of other components.

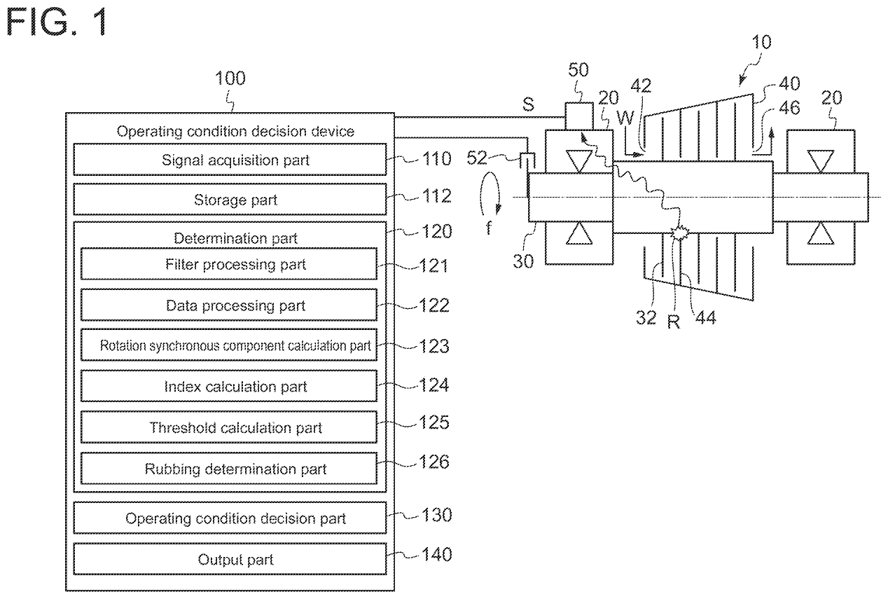

FIG. 1 is a configuration diagram of an operating condition decision device 100 according to the present embodiment, shown together with a rotating machine 10. Although a steam turbine is described in FIG. 1 as an example of the rotating machine 10, the rotating machine 10 is not limited to a steam turbine, but may be a gas turbine, a compressor, or various other rotating machines. The rotating machine 10 of this embodiment has a rotational shaft with a plurality of rows of rotor blades 32, supported at both ends by bearing parts 20, which are fixed parts, and a casing 40 with a plurality of rows of stator vanes 44. The rotor blades 32 and the stator vanes 44 are arranged alternately in each row and housed in the casing 40. An AE sensor 50 is attached to the bearing part 20.

The steam, which is the working fluid W, introduced through an inlet 42 of the casing 40 passes through the rotor blades 32 arranged on the rotational shaft 30 inside the casing and thereby acts on the rotor blades 32 to impart a rotational force to the rotational shaft 30. The stator vanes 44 arranged in the casing 40 regulate the flow of the steam. The steam that has passed through the rotor blades 32 is discharged through an outlet 46.

The AE sensor 50 is configured as a sensor for detecting AE (Acoustic Emission; high frequency output), and outputs AE waves detected as AE signals S. The AE sensor 50 is attached to the bearing part 20.

In the rotating machine 10, for example, a seal attached to the casing 40 that has undergone thermal deformation rubs against the rotational shaft 30, generating AE waves due to rubbing. For example, AE waves generated at the position R, where rubbing occurs, propagate through the surface of the rotational shaft 30 and are detected as AE signals by the AE sensor 50 via the bearing part 20. AE waves generally have frequencies in the sonic range of several 10 kHz to several MHz. The AE signal S detected by the AE sensor 50 contains the frequency of AE waves caused by rubbing and the frequency of noise signals N from other noise.

The AE sensor 50 includes an element for detecting the vibration of AE waves and outputting it as a voltage, and an amplifier for amplifying the voltage from the element and outputting it as electric signals.

A tachometer 52 is configured to detect the rotation speed f of the rotational shaft 30. The tachometer 52 includes, for example, a dog attached to the rotational shaft 30 and a detector for detecting the dog, and when the rotational shaft 30 rotates once and the dog is input once to the tachometer 52, outputs the rotational speed f based on this input. The rotation speed f output from the tachometer 52 can be acquired in synchronization with the AE signal S.

The operating condition decision device 100 includes, for example, a Central Processing Unit (CPU), a Random Access Memory (RAM), a Read Only Memory (ROM), a computer-readable storage medium, and the like. Then, a series of processes for realizing various functions is stored in the storage medium or the like in the form of a program, as an example. The CPU reads the program out to the RAM or the like and executes processing/calculation of information, thereby realizing the various functions. The program may be installed in the ROM or another storage medium in advance, or may be stored in the computer-readable storage medium and provided, or may be distributed through wired or wireless communication means, for example. The computer-readable storage medium may be a magnetic disk, a magneto-optical disk, a CD-ROM, a DVD-ROM, or a semiconductor memory.

As shown in FIG. 1, the operating condition decision device 100 includes a signal acquisition part 110, a storage part 112, a determination part 120, an operating condition decision part 130, and an output part 140.

The signal acquisition part 110 is configured to acquire an AE signal S from the AE sensor. The signal acquisition part 110 acquires the AE signal S from the AE sensor 50 and stores the acquired AE signal S in the storage part 112 as data by executing the program recorded in the storage part 112. The acquisition of the AE signal S is performed at predetermined intervals. The acquisition of the AE signal S may be performed at time intervals of, for example, once every several seconds. For example, the signal acquisition part 110 acquires data for a period of two to four rotations of the rotational shaft in one data acquisition.

The determination part 120 is configured to determine the presence or absence of rubbing, based on the AE signal S acquired by the signal acquisition part 110, and includes a filter processing part 121, a data processing part 122, a rotation synchronous component calculation part 123, an index calculation part 124, a threshold calculation part 125, and a rubbing determination part 126.

The filter processing part 121 performs filter processing on the AE signal S and outputs the filtered AE signal Sf by executing the program stored in the storage part 112. The filter processing part 121 has a filter with pass band of a predetermined frequency component. The pass band of the filter of the filter processing part 121 includes any frequency band from several tens of kHz to several MHz, which are frequency components contained in the AE signal S.

The data processing part 122 performs predetermined envelope processing, resampling, and averaging zero processing on the AE signal S or the filtered AE signal Sf by executing the program stored in the storage part 112. The envelope processing involves envelope processing of the AE signal S or the AE signal Sf to output AE signal Sr from which high-frequency components are removed. The resampling processing involves resampling of the envelope-processed AE signal Sr at a predetermined frequency to output resampled AE signal Sp. The zero average processing involves a process to set the average value of amplitude for each period, which is synchronous average, to zero for the AE signal Sp to output AE signal Sz subjected to zero average processing.

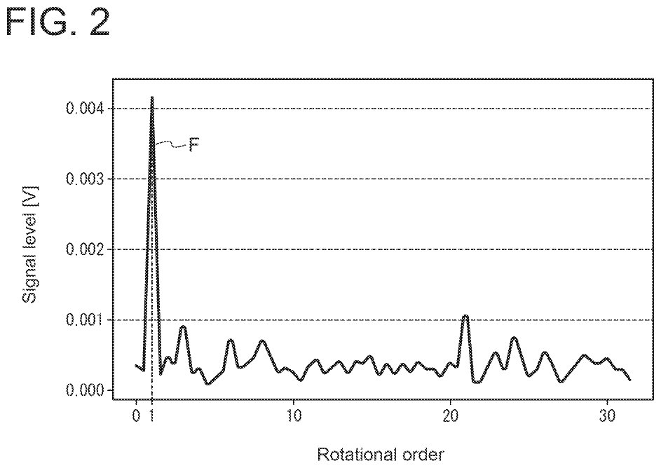

The rotation synchronous component calculation part 123 performs frequency analysis of the AE signal Sz by executing the program stored in the storage part 112. The rotation synchronous component calculation part 123 performs frequency analysis to convert the AE signal Sz, which is a time series function, into a frequency function expressed as amplitude for each frequency, and outputs a rotation order analysis result F where frequency is shown by rotation order (FIG. 2). Here, FIG. 2 is a graph showing the amplitude of AE signals after envelope processing for each rotation order. The rotation order is an order assuming that the frequency component corresponding to the rotation speed f of the rotational shaft 30 is 1. Here, the rotation speed 1× component C has a frequency component with a rotation order of 1 output by the rotation synchronous component calculation part 123.

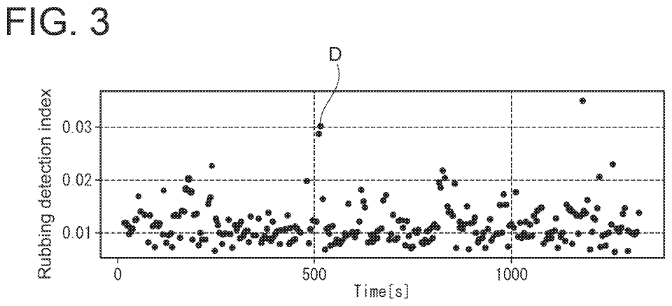

The index calculation part 124 calculates a rubbing detection index D for information on the phase of the AE signal S by executing the program stored in the storage part 112. The rubbing detection index D is obtained as a time-series distribution as shown in FIG. 3. The rubbing detection index D is calculated by the following formula (1).

Rubbing detection index=1/(1+(variance of AE signal phase)\hat{ }0.5) (1)

For example, the variance of the phase of the rotation speed 1× component C is used to calculate the rubbing detection index D. Specifically, the variance of the phase of the rotation speed 1× component C is obtained as the variance of the rotation speed 1× component extracted phase P, which is obtained by performing a predetermined sampling on the phase of the rotation speed 1× component C. The rotation speed 1× component extracted phase P is obtained as the deviation of the period of the rotation speed 1× component from the period of the rotation speed f acquired by the tachometer 52. The extracted phase P of the rotation speed 1× component C is obtained, for example, by sampling 5 to 10 points at intervals of several seconds.

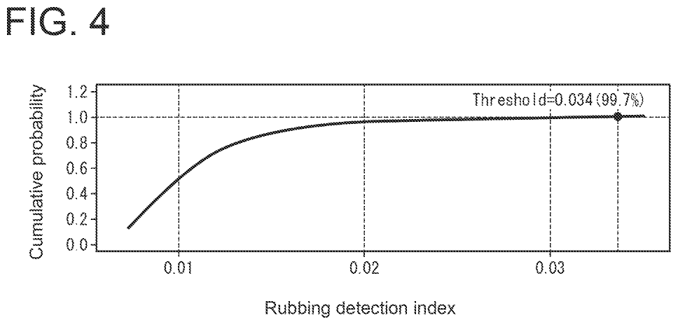

The threshold calculation part 125 obtains a threshold T for determining the presence or absence of rubbing with respect to the rubbing detection index D by executing the program stored in the storage part 112. The threshold T may be calculated, for example, as shown in FIG. 4, from the cumulative probability of the rubbing detection index D when no rubbing occurs. For the threshold T, for example, the cumulative probability may be given in advance, and the rubbing detection index D satisfying the cumulative probability may be calculated as the threshold. For the threshold T, for example, the rubbing detection index D may be given in advance. Specifically, for example, as in the example shown in FIG. 4, the cumulative probability of 99.7% may be given in advance, and the rubbing detection index D0.034 calculated based on this cumulative probability may be used as the threshold T, or, for example, the threshold T may be given in advance as 0.034.

The rubbing determination part 126 determines the presence or absence of rubbing with respect to the rubbing detection index D by executing the program stored in the storage part 112. The presence or absence of rubbing is determined by comparing the rubbing detection index D and the threshold T. The rubbing determination part 126 may be configured to, if the rotating machine 10 is determined to have rubbing, output that the rubbing is present for example to a monitor display.

In this way, by calculating the rubbing detection index based on the information on the phase of the AE signal S, the determination part 120 determines the presence or absence of rubbing based on the rubbing detection index. If the amplitude of the AE signal S of rubbing from the AE sensor 50 is used as the index, in a rotating machine where noise signals from other noises are large, such as a steam turbine, the amplitude of the AE signal of rubbing is smaller than the amplitude of noise signals from other noises and is buried in the noise signals from other noises, so there is a risk that the AE signal of rubbing cannot be detected. The determination part 120 enables rubbing to be detected efficiently with higher accuracy even in a rotating machine with large noise signals from other noises, such as a steam turbine, by calculating the rubbing detection index based on the information on the phase of the AE signal S.

If the determination part 120 determines that rubbing is present, the operating condition decision part 130 then decides a rubbing suppression operating condition, which is an operating condition imposed on the rotating machine 10 to suppress the rubbing. The rubbing suppression operating condition is set for each operation mode of the rotating machine and is specified as an operating condition necessary to suppress the rubbing in the operating state of the rotating machine 10 in each operation mode.

In this embodiment, the rotating machine 10 has multiple operation modes, and among the multiple operation modes, rubbing suppression operating conditions are set for several operation modes in which rubbing is relatively likely to occur. For example, among the operation modes of the rotating machine 10, the quick start mode, the load fluctuation mode, and the low load operation mode tend to cause rubbing because they are accompanied by fluctuations in the rotation speed or load of the rotating machine 10.

The quick start mode is a mode to quickly start the rotating machine 10 in the stop state, and the rotation speed of the rotating machine 10 rapidly increases. In the load fluctuation mode, the load of the rotating machine 10 fluctuates based on an external output command. In the low load operation mode, when the operation of the rotating machine 10 is no longer required by an external output command, the rotating machine 10 is maintained in a low-load state without stopping, and when the operation of the rotating machine 10 is again required by an output command, the load following is carried out with good response. These operation modes are increasingly being implemented in the rotating machine 10 in recent years, for example, when the rotating machine 10 is a steam turbine connected to a generator in a power plant, as the share of natural energy in the electrical grid increases. That is, natural energy is relatively unstable because it fluctuates with environmental conditions, and the rotating machine 10 is increasingly controlled in these operation modes in response to output commands to power plants to meet electricity demand.

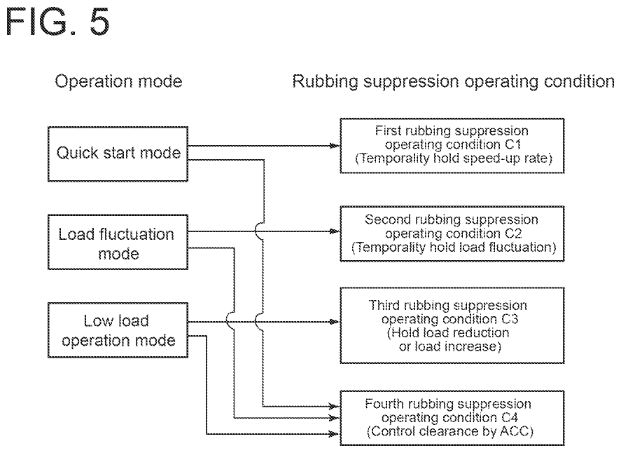

Here, FIG. 5 shows examples of the rubbing suppression operating condition set for some operation modes. In this example, a first rubbing suppression operating condition C1, a second rubbing suppression operating condition C2, and a third rubbing suppression operating condition C3 are set for the quick start mode, the load fluctuation mode, and the low load operation mode, respectively.

The first rubbing suppression operating condition C1 is a rubbing suppression operating condition corresponding to the quick start mode, and is set to temporarily hold the rotation speed of the rotating machine 10 which rises with the passage of time during quick startup. Specifically, it is set to, when the determination part 120 determines that rubbing is present at the time of quick startup of the rotating machine 10, hold the rotation speed of the rotating machine 10 at that time, and then when it is determined that there is no longer rubbing (i.e., when it is determined that the rubbing is eliminated), resume increasing the rotation speed of the rotating machine 10. Thus, when the determination part 120 determines that rubbing is present, the progress of the rubbing can be suppressed by temporarily stopping the quick startup.

The second rubbing suppression operating condition C2 is a rubbing suppression operating condition corresponding to the load fluctuation mode, and is set to temporarily hold the load fluctuation when the rotating machine 10 operates while changing the load in response to an external output command. Specifically, it is set to, when the determination part 120 determines that rubbing is present at the time of load fluctuation of the rotating machine 10, hold the load of the rotating machine 10 at that time, and then when it is determined that there is no longer rubbing (i.e., when it is determined that the rubbing is eliminated), resume the load fluctuation of the rotating machine 10. Thus, when the determination part 120 determines that rubbing is present, the progress of the rubbing can be suppressed by temporarily stopping the load fluctuation.

The third rubbing suppression operating condition C3 is a rubbing suppression operating condition corresponding to the low load operation mode, and is set to, when reducing the load of the rotating machine 10 so that the rotating machine 10 operates at low load in response to an external output command, stop reducing the load to maintain the load or temporarily increase the load. Specifically, it is set to, when the determination part 120 determines that rubbing is present at the time of load reduction of the rotating machine 10, change the load reduction of the rotating machine 10 at that time to maintain or temporarily increase the load, and then when it is determined that there is no longer rubbing (i.e., when it is determined that the rubbing is eliminated), resume the load reduction of the rotating machine 10. Thus, when the determination part 120 determines that rubbing is present, the progress of the rubbing can be suppressed by temporarily suspending the load reduction.

The operating condition decision part 130 may also specify a fourth rubbing suppression operating condition C4 for ACC control to increase (or enlarge) the size of the gap between the rotating part and the stationary part of the rotating machine 10 to mitigate the rubbing as another rubbing suppression operating condition. The size of the gap may be adjusted by thermal expansion (or thermal contraction), for example, by heating a fixed part (e.g., a stationary member such as a casing or a blade ring) of the rotating machine that defines the gap, or by adjusting the pressure in the gap (more specifically, the ambient pressure of a member that defines the gap, such as a seal ring) through valve opening/closing control to move a member (e.g., a seal ring) that defines at least part of the gap.

The rubbing suppression operating condition may be commonly associated with multiple operation modes. In FIG. 5, the fourth rubbing suppression operating condition C4 is commonly associated with the quick start mode, the load fluctuation mode, and the low load operation mode.

The rubbing suppression operating condition for each operation mode is stored in advance in the storage part 112 in association with each other. The operating condition decision part 130 identifies the operation mode implemented in the rotating machine 10 and selects the rubbing suppression operating condition corresponding to this operation mode from the storage part 112 to decide the operating condition. Then, the operating condition decided by the operating condition decision part 130 is output to an external device from the output part 140.

As described above, with the operating condition decision device 100 according to the present embodiments, the occurrence of rubbing is determined at an early stage based on acoustic signals acquired with the AE sensor, and if the rubbing is determined to be present, the rubbing suppression operating condition imposed on control of the rotating machine is decided to suppress the rubbing. By imposing the rubbing suppression operating condition thus decided on the rotating machine, the rubbing is suppressed, avoiding emergency stopping or the like of the rotating machine and effectively extending the operating range.

<Operation Assistance Device>

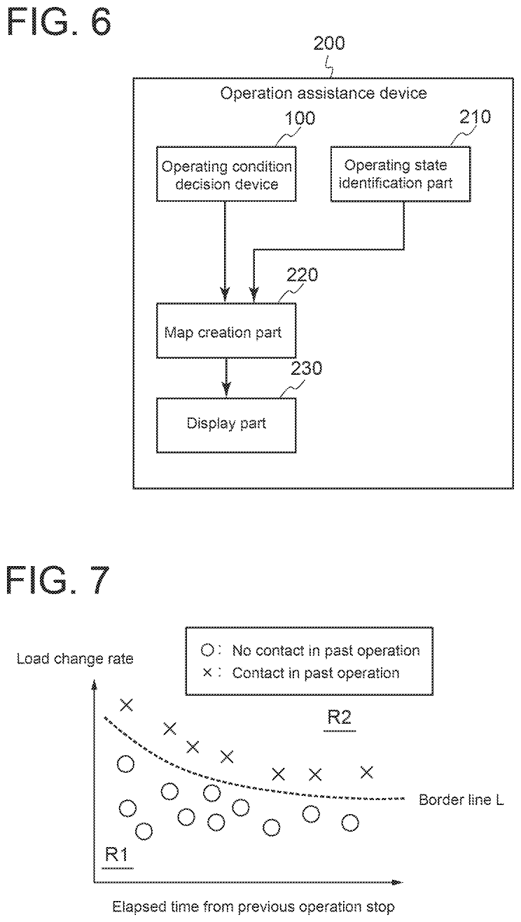

Next, an operation assistance device 200 for a rotating machine 10 using the above-described operating condition decision device 100 will be described. FIG. 6 is a configuration diagram of an operation assistance device 200 for a rotating machine 10 equipped with the operating condition decision device 100 of FIG. 1. The operation assistance device 200 includes an operating condition decision device 100, an operating state identification part 210, a map creation part 220, and a display part 230.

The operating condition decision device 100 has the configuration described above, and in particular, the determination part 120 determines the presence or absence of rubbing in the rotating machine 10. Further, the operating state identification part 210 identifies the operating state of the rotating machine 10 in synchronization with the determination part 120. The operating state of the rotating machine 10 is defined by at least one parameter.

The map creation part 220 creates a map based on the determination result of the determination part 120 and the operating state identified by the operating state identification part 210. Here, FIG. 7 is an example of the map created by the map creation part 220 of FIG. 6. In the example of FIG. 7, the operating state is identified by two parameters, “load change rate” and “elapsed time from previous operation stop”, and the rubbing determination results at each point indicating the past operating state of the rotating machine 10 are shown. This shows that the range R1, where the rubbing determination result is “absence”, and the range R2, where the rubbing determination result is “presence”, are distributed with the border line L and indicates that rubbing tends to occur at a smaller load change rate as the elapsed time from the previous stop increases.

Although FIG. 7 shows the case where the operating state of the rotating machine is identified by two parameters, “load change rate” and “elapsed time from previous operation stop”, the operating state of the rotating machine 10 may be identified by other parameters, such as the speed-up rate of rotation speed or minimum load of the rotating machine 10.

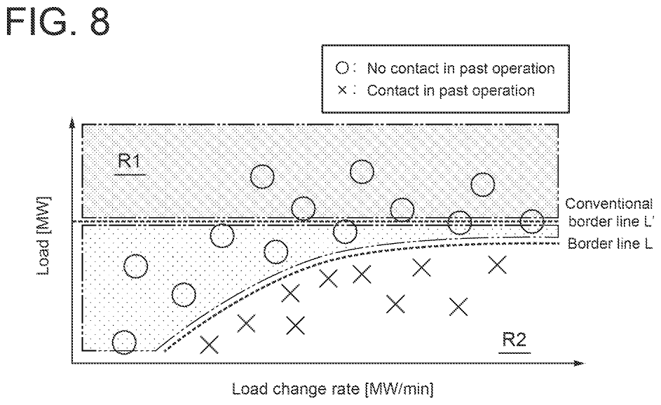

FIG. 8 is another example of the map created by the map creation part 220 of FIG. 6. In the example of FIG. 8, the operating state is identified by two parameters, “load change rate” and “load”, and the rubbing determination results at each point indicating the past operating state of the rotating machine 10 when shifting to low load operation by reducing the load of the rotating machine 10 are shown. As in FIG. 7, FIG. 8 shows that the range R1, where the rubbing determination result is “absence”, and the range R2, where the rubbing determination result is “presence”, are distributed with the border line L, and the larger the load change rate for reducing the load, the larger the load that can be reached without rubbing.

Conventionally, an excessive margin has been set for the border line L to prevent the occurrence of rubbing in the rotating machine 10, such as the border line L′ to presume the ranges R1 and R2. In contrast, in the present embodiment, the rubbing determination using the AE sensor can accurately determine rubbing occurring in the rotating machine 10 at an earlier stage, thus eliminating the need to set an excessive margin and extending the operating range of the rotating machine 10 compared to the conventional method, as shown by the border line L.

The display part 230 is configured to display the map created by the map creation part 220 in a user-recognizable manner, for example, on a display. By referring to the map displayed on the display part 230, the operator of the rotating machine 10 can easily grasp the operating range where rubbing does not occur and control the rotating machine 10 so that the operating state of the rotating machine 10 does not deviate from this operating range, thereby enabling operation that effectively avoids the occurrence of rubbing.

As described above, with the operation assistance device 200 according to the present embodiment, by displaying the map showing a correlation between the determination result of the determination part 120 and the operating state identified by the operating state identification part 210 on the display part 230, operation assistance can be provided to control the rotating machine 10 so that the operating state of the rotating machine 10 does not deviate from the operating range.

<Control Device>

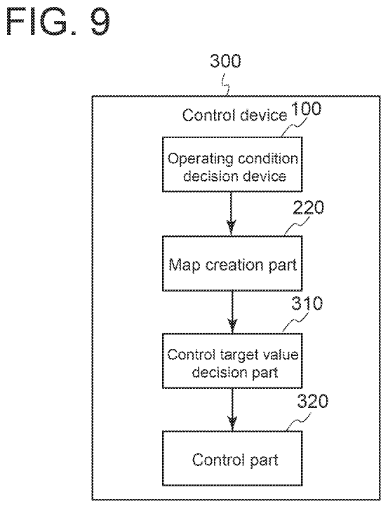

Next, a control device 300 for a rotating machine 10 using the above-described operating condition decision device 100 will be described. FIG. 9 is a configuration diagram of a control device 300 for a rotating machine 10 equipped with the operating condition decision device 100 of FIG. 1.

The control device 300 includes an operating condition decision device 100, a map creation part 220, a control target value decision part 310, and a control part 320. The control device 300 includes an operating condition decision device 100, an operating state identification part 210, a map creation part 220, a control target value decision part 310, and a control part 320.

The operating state identification part 210 and the map creation part 220 are the same as in the operation assistance device 200 described above, and thus will not be described again here.

The control target value decision part 310 decides a control target value for a control parameter of the rotating machine 10, based on the map created by the map creation part 220. Specifically, the control target value decision part 310 determines whether the original control target value calculated based on an external output command is within the range R1 in the map where the rubbing determination result is “absence”. As a result, if the original control target value is within the range R1, the original control target value is adopted as it is.

On the other hand, if the original control target value is not within the range R1, the control target value decision part 310 makes a correction so that the original control target value is within the range R1. This correction may be made, for example, with a predetermined margin with respect to the border line L between the range R1 and the range R2. This enables correction to the control target value that can effectively prevent the occurrence of rubbing while reducing the deviation from the original control target value corresponding to the output command.

Further, the control part 320 controls the control parameter of the rotating machine 10, based on the control target value decided by the control target value decision part 310. As a result, follow-up control of the rotating machine 10 can be achieved appropriately in response to an output command while avoiding the occurrence of rubbing.

In addition, the components in the above-described embodiments may be appropriately replaced with known components without departing from the spirit of the present disclosure, or the above-described embodiments may be appropriately combined.

The contents described in the above embodiments would be understood as follows, for instance.

(1) An operating condition decision device for a rotating machine according to one aspect includes: a signal acquisition part for acquiring an AE signal from an AE sensor disposed on a fixed part of the rotating machine; a determination part for determining the presence or absence of rubbing in the rotating machine, based on the AE signal; and an operating condition decision part for, if the determination part determines that the rubbing is present, deciding a rubbing suppression operating condition imposed on control of the rotating machine to suppress the rubbing.

According to the above aspect (1), the occurrence of rubbing is determined at an early stage based on the AE signal acquired with the AE sensor, and if the rubbing is determined to be present, the rubbing suppression operating condition imposed on control of the rotating machine is decided to suppress the rubbing. By imposing the rubbing suppression operating condition thus decided on the rotating machine, the rubbing is suppressed, avoiding emergency stopping or the like of the rotating machine and effectively extending the operating range.

(2) In another aspect, in the above aspect (1), the rubbing suppression operating condition is set in advance for each operation mode of the rotating machine. The operating condition decision part is configured to select the rubbing suppression operating condition corresponding to the operation mode implemented in the rotating machine when the determination part determines that the rubbing is present.

According to the above aspect (2), by selecting the rubbing suppression operating condition corresponding to the operation mode, the rubbing occurring in the rotating machine in each operation mode can be effectively suppressed.

(3) In another aspect, in the above aspect (2), the operation mode involves fluctuations in rotation speed or load of the rotating machine.

According to the above aspect (3), by setting the rubbing suppression operating condition for the operation mode that tends to cause rubbing due to fluctuations in the rotation speed or load of the rotating machine 10, the rubbing in the rotating machine can be effectively suppressed.

(4) In another aspect, in the above (2) or (3), if the operation mode implemented in the rotating machine is a start mode in which the rotating machine is started in response to an output command, the operating condition decision part decides the rubbing suppression operating condition so that a rotation speed of the rotating machine when the rubbing is determined to be present is temporarily maintained or a speed-up rate is decreased.

According to the above aspect (4), if the rubbing is determined to be present when the rotation speed of the rotating machine increases with the passage of time in the start mode, the rubbing suppression operating condition is decided so as to temporarily maintain (hold) the rotation speed of the rotating machine (i.e., temporarily stop the start process of the rotating machine) or decrease the speed-up rate. Thus, it is possible to effectively prevent the progress of the rubbing with an increase in rotation speed at startup.

(5) In another aspect, in the above (2) or (3), if the operation mode implemented in the rotating machine is a load fluctuation mode in which a load of the rotating machine fluctuates in response to an output command, the operating condition decision part decides the rubbing suppression operating condition so that the load of the rotating machine when the rubbing is determined to be present is temporarily maintained.

According to the above aspect (5), if the rubbing is determined to be present when the load of the rotating machine increases with the passage of time in the load fluctuation mode, the rubbing suppression operating condition is decided so as to temporarily maintain (hold) the load of the rotating machine (i.e., control the load of the rotating machine substantially constant). Thus, it is possible to effectively prevent the progress of the rubbing with the load fluctuation of the rotating machine.

(6) In another aspect, in the above (2) or (3), if the operation mode implemented in the rotating machine is a low load operation mode in which the rotating machine is operated at low load in response to an output command, the operating condition decision part decides the rubbing suppression operating condition so that a load of the rotating machine when the rubbing is determined to be present is maintained or increased.

According to the above aspect (6), if the rubbing is determined to be present when the load of the rotating machine is decreased with the passage of time to transition to the low load mode, the rubbing suppression operating condition is decided so as to maintain (temporarily hold) or increase the load of the rotating machine. Thus, it is possible to effectively prevent the progress of the rubbing with the load reduction of the rotating machine.

(7) In another aspect, in the above (2) or (3), the operating condition decision part is configured to, if the rubbing is determined to be present, decide the rubbing suppression operating condition so that a clearance between the fixed part and a rotating part in the rotating machine is increased.

According to the above aspect (7), if the rubbing is determined to be present in the rotating machine, the rubbing can be suppressed by increasing (or enlarging) the clearance between the fixed part and the rotating part.

(8) In another aspect, in any one of the above aspects (1) to (7), the determination part is configured to determine the presence or absence of the rubbing, based on a rubbing detection index calculated based on information on a phase of the AE signal.

According to the above aspect (8), by determining the presence or absence of rubbing on the basis of the rubbing detection index calculated based on information on the phase of the AE signal, the rubbing of the rotating machine can be detected before the rotational shaft undergoes shaft vibration, and the rubbing of the rotating machine can be detected efficiently and accurately.

(9) An operation assistance device for a rotating machine according to one aspect includes: the operating condition decision device for the rotating machine according to any one aspect of (1) to (8); an operating state identification part for identifying an operating state of the rotating machine; a map creation part for creating a map based on a determination result of the determination part and the operating state identified by the operating state identification part; and a display part for displaying the map created by the map creation part.

According to the above aspect (9), by displaying the map showing a correlation between the rubbing determination result and the operating state of the rotating machine on the display part, operation assistance can be provided for the operator to operate the rotating machine so that the operating state of the rotating machine does not deviate from the operating range.

(10) A control device for a rotating machine according to one aspect includes: the operating condition decision device for the rotating machine according to any one aspect of (1) to (8); an operating state identification part for identifying an operating state of the rotating machine; a map creation part for creating a map based on a determination result of the determination part and the operating state identified by the operating state identification part; a control target value decision part for deciding a control target value for a control parameter of the rotating machine, based on the map created by the map creation part; and a control part for controlling the control parameter, based on the control target value decided by the control target value decision part.

According to the above aspect (10), the control target value of the control parameter is decided within a range where rubbing does not occur in the rotating machine, based on the map showing a correlation between the rubbing determination result and the operating state of the rotating machine. Further, by controlling the rotating machine so that the control parameter of the rotating machine reaches the decided control target value, follow-up control of the rotating machine can be achieved appropriately in response to an output command while avoiding the occurrence of rubbing.

(11) An operating condition decision method for a rotating machine according to one aspect includes: a step of acquiring an AE signal from an AE sensor disposed on a fixed part of the rotating machine; a step of determining the presence or absence of rubbing in the rotating machine, based on the AE signal; and a step of, if the rubbing is determined to be present by the determination part, deciding a rubbing suppression operating condition imposed on control of the rotating machine to suppress the rubbing.

According to the above aspect (11), the occurrence of rubbing is determined at an early stage based on the AE signal acquired with the AE sensor, and if the rubbing is determined to be present, the rubbing suppression operating condition imposed on control of the rotating machine is decided to suppress the rubbing. By imposing the rubbing suppression operating condition thus decided on the rotating machine, the rubbing is suppressed, avoiding emergency stopping or the like of the rotating machine and effectively extending the operating range.

### REFERENCE SIGNS LIST

10 Rotating machine
20 Bearing part
30 Rotational shaft
32 Rotor blade
40 Casing
42 Inlet
44 Stator vane
46 Outlet
50 Sensor
52 Tachometer
100 Operating condition decision device
110 Signal acquisition part
112 Storage part
120 Determination part
121 Filter processing part
122 Data processing part
123 Rotation synchronous component calculation part
124 Index calculation part
125 Threshold calculation part
126 Rubbing determination part
130 Operating condition decision part
140 Output part
200 Operation assistance device
210 Operating state identification part
220 Map creation part
230 Display part
300 Control device
310 Control target value decision part
320 Control part

1. An operating condition decision device for a rotating machine, comprising:
a signal acquisition part for acquiring an AE signal from an AE sensor disposed on a fixed part of the rotating machine;
a determination part for determining the presence or absence of rubbing in the rotating machine, based on the AE signal; and
an operating condition decision part for, if the determination part determines that the rubbing is present, deciding a rubbing suppression operating condition imposed on control of the rotating machine to suppress the rubbing.

2. The operating condition decision device for the rotating machine according to claim 1,
wherein the rubbing suppression operating condition is set in advance for each operation mode of the rotating machine, and
wherein the operating condition decision part is configured to select the rubbing suppression operating condition corresponding to the operation mode implemented in the rotating machine when the determination part determines that the rubbing is present.

3. The operating condition decision device for the rotating machine according to claim 2,
wherein the operation mode involves fluctuations in rotation speed or load of the rotating machine.

4. The operating condition decision device for the rotating machine according to claim 2,
wherein, if the operation mode implemented in the rotating machine is a start mode in which the rotating machine is started in response to an output command, the operating condition decision part decides the rubbing suppression operating condition so that a rotation speed of the rotating machine when the rubbing is determined to be present is temporarily maintained or a speed-up rate is decreased.

5. The operating condition decision device for the rotating machine according to claim 2,
wherein, if the operation mode implemented in the rotating machine is a load fluctuation mode in which a load of the rotating machine fluctuates in response to an output command, the operating condition decision part decides the rubbing suppression operating condition so that the load of the rotating machine when the rubbing is determined to be present is temporarily maintained.

6. The operating condition decision device for the rotating machine according to claim 2,
wherein, if the operation mode implemented in the rotating machine is a low load operation mode in which the rotating machine is operated at low load in response to an output command, the operating condition decision part decides the rubbing suppression operating condition so that a load of the rotating machine when the rubbing is determined to be present is maintained or increased.

7. The operating condition decision device for the rotating machine according to claim 2,
wherein the operating condition decision part is configured to, if the rubbing is determined to be present, decide the rubbing suppression operating condition so that a clearance between the fixed part and a rotating part in the rotating machine is increased.

8. The operating condition decision device for the rotating machine according to claim 1,
wherein the determination part is configured to determine the presence or absence of the rubbing, based on a rubbing detection index calculated based on information on a phase of the AE signal.

9. An operation assistance device for a rotating machine, comprising:
the operating condition decision device for the rotating machine according to claim 1;
an operating state identification part for identifying an operating state of the rotating machine;
a map creation part for creating a map based on a determination result of the determination part and the operating state identified by the operating state identification part; and
a display part for displaying the map created by the map creation part.

10. A control device for a rotating machine, comprising:
the operating condition decision device for the rotating machine according to claim 1;
an operating state identification part for identifying an operating state of the rotating machine;
a map creation part for creating a map based on a determination result of the determination part and the operating state identified by the operating state identification part;
a control target value decision part for deciding a control target value for a control parameter of the rotating machine, based on the map created by the map creation part; and
a control part for controlling the control parameter, based on the control target value decided by the control target value decision part.

11. An operating condition decision method for a rotating machine, comprising:
a step of acquiring an AE signal from an AE sensor disposed on a fixed part of the rotating machine;
a step of determining the presence or absence of rubbing in the rotating machine, based on the AE signal; and
a step of, if the rubbing is determined to be present by the determination part, deciding a rubbing suppression operating condition imposed on control of the rotating machine to suppress the rubbing.
